(19) United States
(12) Patent Application Publication
(10) Pub. No.: US 2010/0099341 A1
(43) Pub. Date: Apr. 22, 2010

(54) ERGONOMIC THROTTLE LEVER CONTROL AND HAND SUPPORT

(75) Inventors: Paul W. Huber, Lancaster, NY (US); Robert A. Geiser, Elma, NY (US)

Correspondence Address: PATRICIA M. COSTANZO;PATS PENDING, P.O. BOX 101, ELMA, NY, 14059, US

(73) Assignee: X'POLE PRECISION TOOLS, INC., Chung-Li City (TW)

(21) Appl. No.: 12/581,968

(22) Filed: Oct. 20, 2009

Related U.S. Application Data
(60) Provisional application No. 61/106,678, filed on Oct. 20, 2008.

(51) Int. Cl. B24B 23/00; G05G 1/04

(52) U.S. Cl. 451/357; 74/524

(57) ABSTRACT

A lever longer than wide and bent across its length producing an angle of <180° between an upper surface of a longer first and a shorter second lever end to control the throttle switch of a hand-held tool by hand-rocking the lever about its vertex to exert pressure on or release pressure from the switch, the lever designed to support a user's fingers and palm while using the tool. Attachment tabs extend downwards from opposing sides of the first end adjacent the vertex, each tab having an aperture for accepting an attachment pin so to pivotally engage the lever within pin receiving apertures of the tool to rotate the lever both toward and away from the actuator switch, the second end extending over an exhaust-outlet or air-intake of the hand-held power tool to protect the user's hand from coming into contact with the tool's exhaust-outlet or air-intake.

### CROSS-REFERENCE TO RELATED APPLICATIONS

This Application claims the benefit of U.S. Provisional Application No. 61/106,678, filed Oct. 20, 2008.

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND

The present invention relates generally to throttle levers, and more particularly, to ergonomically designed throttle levers for use with handheld powered tools.

The background information discussed below is presented to better illustrate the novelty and usefulness of the present invention. This background information is not admitted prior art.

Hand-held, portable, powered, non-vacuum or vacuum, non-rotary, rotary, orbital, and random-orbital sanders and other handheld abrading or abrasive tools are known. These tools generally have a motor, a housing for a motor, a grip over the housing, an abrading surface powered by the motor, an air-inlet port, an exhaust outlet, and a throttle-switch.

### SUMMARY

The present inventor recognized that in order to use the throttle lever of presently available tools an operator is required to arch his wrist while using the sander, which stresses the wrist and arm and, eventually can be the cause of chronic injuries, such as carpal tunnel syndrome. This happens in the tools that are so designed that the operator must press downwards on the throttle lever situated on the top of the housing while at the same time arching his or her wrist out of the way of the attached air hose. For pneumatic sanders, the operator must, additionally, keep out of the way of the power cord, and/or dust and air exhaust. One particular example of a tool that requires an operator to maintain an uncomfortable hand position is a handheld, pneumatic, surface-treating device has a relatively large switch that must be held by the operator's gripping hand as the surface treating device is operated, and additionally, there is an air-inlet and exhaust extending out from the housing under the switch. Because this device lacks a hand/wrist support, the operator's wrist must be arched and his or her hand must be cupped in order to hold the switch and simultaneously maneuver the tool on the surface to be treated. Another tool, similar in structure, features a dust-bag outlet extending from beneath the switch, but provides no stable component upon which the operator's wrist or forearm can rest. Another tool offers an exhaust duct designed to have a curved shape making it unsuitable for supporting a wrist and to be positioned below the level of the switch, making the duct unavailable for providing a wrist or forearm rest, even if the shape of the duct was more suitable.

The present inventor realized that although the more recent handheld abrasive tools are somewhat more user friendly, in that they offer a hand support even thought they maintain the switch under the throttle, they still suffer from several design flaws. One is that their throttle switch is separate and spaced apart from the portion of the tool body that is intended to function as a hand-support. The space between the throttle switch and the hand-support creates a hand-skin pinching hazard. In order to use the sander, that is to provide power to the motor, these models require an operator to press the front part (finger area) of his/her hand downwards on the throttle lever situated on the top of the housing and to stop the action of the tool, the operator must stop pressing downward with the front part of his hand. To do this however, the operator must raise his hand upward off of the lever while maintaining a grip on the tool. This action creates a stress on the hand, wrist, and arm muscles and reduces an operator's control of the tool. Such strained gripping positions can lead to long-term, if not permanent damage to the hand, wrist, and/or distal portion of the forearm. In addition, the weight and bulk of an operator's hand and arm may cause the throttle switch to rotate faster than desired.

Accordingly, the present inventor conceived a set of principles that provide abrasive and abrading tool assemblies having a motor, a housing over the motor, a grip over the housing, an air-inlet port, an exhaust outlet, and a throttle-switch-hand-support element. The principles behind the present invention provide for a one-piece hand-support element unit that not only supports an operator's hand, but provides for throttle control as well resulting in effectively relieving stress on an operator's wrist and forearm. Following the principles, as taught herein, the throttle-switch-hand-support is attached to the abrading tool and extends over the air-inlet port and dust-bag outlets. The one-piece design of the throttle-switch-hand-support eliminates the need for an operator to lift his hand off of a switch in order to reduce rotating velocity. To reduce or increase velocity using the switch of the present invention, all the operator has to do is to rock his hand back or forth, respectively, while allowing the weight of the hand to remain supported by the throttle-switch-hand-support. In one embodiment, the abrading tool is a rotary tool. In an alternate embodiment, the air-inlet port may be replaced by an electric power cord in electrically powered tools.

A lever made according to the principles of the present invention are made possible by providing for a lever for controlling a throttle switch, comprising an elongate lever having an upper surface, a first end, and a second end, the lever bent across its length producing an angle of less than 180 degrees between the upper surface of the first end and the upper surface of the second end so as to enable control of a throttle switch by hand-rocking the lever to rotate about its angle's vertex to exert pressure on or release pressure from the throttle switch, the lever having a length sufficient so as to support the fingers and palm of a user, wherein the throttle switch is a switch on a hand-held power tool, and further having attachment tabs positioned on opposing sides of the lever, the attachment tabs providing for attachment of the lever to the handheld tool.

The length of the lever is designed to extend over an exhaust-outlet or an air-intake of the hand-held power tool so as to protect the user's hand from coming into contact with the tool's exhaust-outlet or air-intake and has a check tab formed from a partial cut-out of the lever, the check tab positioned so as to extend to the handheld tool to limit the extent the lever can rotate.

The lever is also taught as used in combination with a handheld tool, comprising a handheld power tool having a throttle switch, and an elongate lever for controlling the throttle switch, the lever comprising an upper surface, a first end, and a second end, the lever bent across its length producing a vertex and an angle of less than 180 degrees between the upper surface of the first end and the upper surface of the second end so as to enable control of a throttle switch by hand-rocking the lever to rotate about its angle's vertex so as to exert pressure on or release pressure from the throttle switch, the lever having a length sufficient so as to support the fingers and palm of a user, further having attachment tabs positioned on opposing sides of the lever, the attachment tabs providing for attachment of the lever to the tool, and designed of a length to extend over an exhaust-outlet and/or an air-intake of the tool so as to protect user's hand from coming into contact with the tool's exhaust-outlet or air-intake. The further having a check tab formed from a partial cut-out of the lever, the check tab positioned so as to extend to the tool to limit the extent the lever can rotate.

The lever is contemplated for use with any handheld power tool, including but not limited to an abrading tool, a sanding tool, a non-rotary action sanding tool, a rotary action sanding tool, an orbital action sanding tool, a random-orbital action sanding tool, a vacuum sanding tool, a non-vacuum sanding tool, and a vacuum random-orbital action sanding tool.

Still other benefits and advantages of this invention will become apparent to those skilled in the art upon reading and understanding the following detailed specification and related drawings.

### BRIEF DESCRIPTION OF THE DRAWINGS

In order that these and other objects, features, and advantages of the present invention may be more fully comprehended and appreciated, the invention will now be described, by way of example, with reference to specific embodiments thereof which are illustrated in appended drawings wherein like reference characters indicate like parts throughout the several figures. It should be understood that these drawings only depict preferred embodiments of the present invention and are not therefore to be considered limiting in scope, thus, the invention will be described and explained with additional specificity and detail through the use of the accompanying drawings, in which:

FIG. 1 is a perspective view of a Prior Art throttle lever.

FIG. 2 is a top plan view of a Prior Art throttle lever.

FIG. 3 is a perspective view of a Prior Art throttle lever.

FIG. 4 is a perspective view of a Prior Art throttle lever of a surface treatment tool.

FIG. 5 is a top plan view of a Prior Art throttle lever of a surface treatment tool.

FIG. 6 is an elevation view of a Prior Art throttle lever of a surface treatment tool.

FIG. 7 is a perspective view of the top surface of a throttle lever of the present invention.

FIG. 8 is a perspective view of the bottom surface of a throttle lever of the present invention.

FIG. 9 is a cross-sectional perspective side and bottom view taken along A′-A′ of FIG. 10 illustrating the five degree upwards tilt of the rear section of a throttle lever of the present invention.

FIG. 10 is a plan view of the top surface of a throttle lever of the present invention.

FIG. 11 is a perspective view of the top and side of a throttle lever of the present invention.

FIG. 12 is a top plan view of a surface treatment tool fitted with a throttle lever of the present invention.

FIG. 13 is a perspective view of the upper surfaces of a surface treatment tool having the throttle lever of the present invention.

FIG. 14 is an elevation side view of a surface treatment tool with a perspective view of a throttle lever according to the principles of the present invention.

### A LIST OF REFERENCE CHARACTERS AND PARTS WHICH CHARACTERS REFER

5 A throttle-switch-hand-support lever of the present invention.
6 A Prior Art throttle lever.
8 Aperture in attachment tabs 14 for insertion of attachment pin.
10 A Prior Art surface treatment tool.
12 A bent tab extending from the bottom surface of the support and throttle lever of the present invention that prevents the support and throttle lever from rotating too far upwards.
14 Attachment tabs attaching support and throttle lever to tool.
16 Value actuator switch for turning power on and off.
18 Grip.
20 A surface treatment tool utilizing the ergonomic support and throttle lever of the present invention.
22 Working surface, such as an abrasive.
24 Pad.
26 Housing.
28 Inlet.
30 Lever extension.
32 Lever attachment.
34 Exhaust.

It should be understood that the drawings are not necessarily to scale. In certain instances, details which are not necessary for an understanding of the present invention or which render other details difficult to perceive may have been omitted.

### DETAILED DESCRIPTION

Referring now, with more particularity, to the drawings, it should be noted that the disclosed invention is disposed to embodiments in various sizes, shapes, and forms. For example, the overall size of the lever could increase or decrease depending on which size model of a particular tool the handle is to be employed. The handle could be provided in various sizes to take into consideration the size of the operator's hand. The general shape of the handle could be changed, such as making the extension of the handle wider, longer, or even shaped to have curved edges or a rounded surface. Therefore, the embodiments described herein are provided with the understanding that the present disclosure is intended as illustrative and is not intended to limit the invention to the embodiments described herein.

The present invention is particularly directed to a throttle-switch-hand-support lever for use on abrasive or abrading tools. The tools according to the principles of the present invention are generally provided with a motor, a housing over the motor, a grip over the housing, an air-inlet port, an exhaust outlet, and an elongated, angled, throttle-switch-hand-support lever to provide support an operator's hand so as to reduce stress on the operator's wrist and forearm. It is to be understood that the present invention may be utilized with a variety of hand-held powered tools, which includes tools with non-rotary, rotary, orbital, and random-orbital actions, as well as tools that are non-vacuum or vacuum. One favored embodiment features a pneumatically powered abrading tool with a one-piece, continuous, elongated, angled, throttle-switch-hand-support lever extending from over the valve actuator switch to over the air-inlet and exhaust ports.

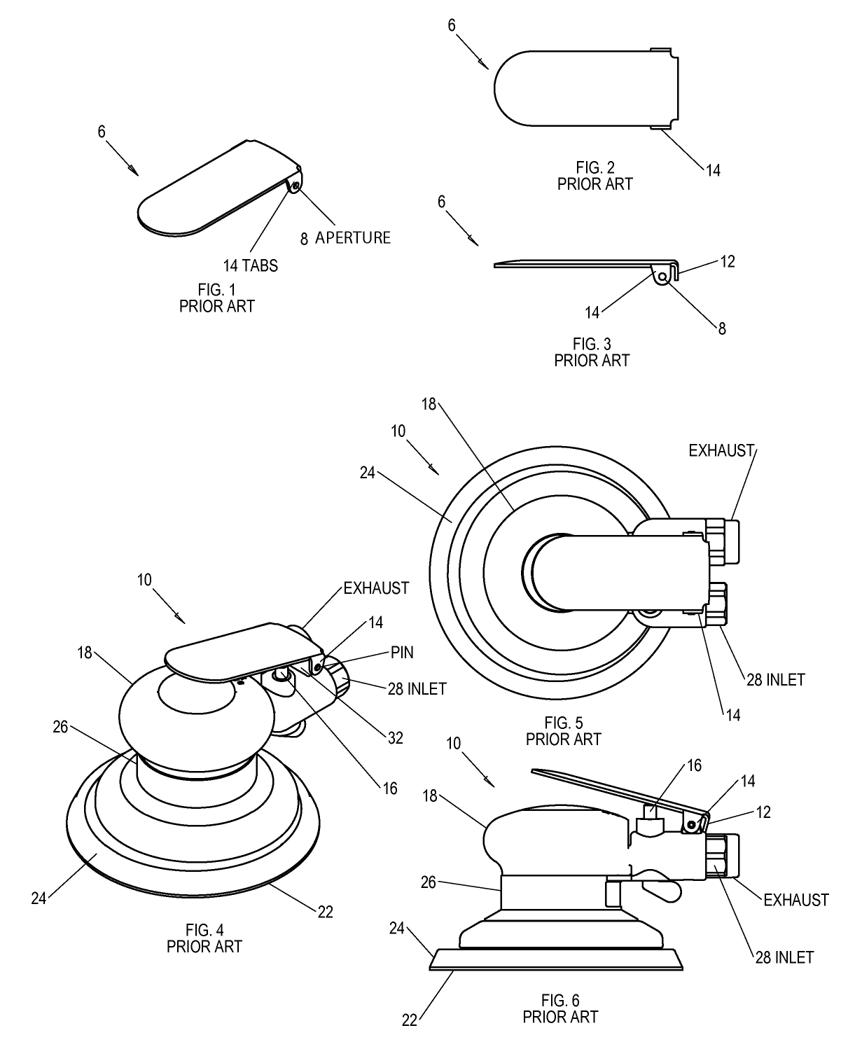

Turning now to the drawings, FIGS. 1-3 provide various views of a throttle lever that does not incorporate the principles of the present invention, and FIGS. 4-6 provide various views of a presently available surface treatment tool fitted with the old style throttle lever. Tool 10 is designed to be held by one hand. Housing 26, grip 18 over the housing, pad 24 having abrasive material 22, such as sandpaper, attached thereto to be applied to the surface to be treated, air intake 28, an exhaust extending from housing 26, switch 16, and short, flat switch lever 6. To apply power to tool 10, the short, flat throttle lever 6 must be pressed downward to activate the motor. Lever 6 can not provide any support or protection for the operator's hand, as it is not long enough and it is not ergonomically shaped. Because the lever does not extend over the exhaust and intake area, it is not able to provide protection for the operator's hand from the effects of the exhaust and air intake. Thus, the operator must maintain his hand in an upwardly bent position to avoid the exhaust and air intake. A result of the operator having to maintain his hand in an upwardly bent position is that more weight and force from the front part of his hand is directed onto lever 6. This, in turn, results in it being more difficult for the operator to release the pressure of the front of his hand on the lever to stop the action. The sum of these competing forces will likely cause an operator's hand to feel the stress and to tire easily while using such a tool.

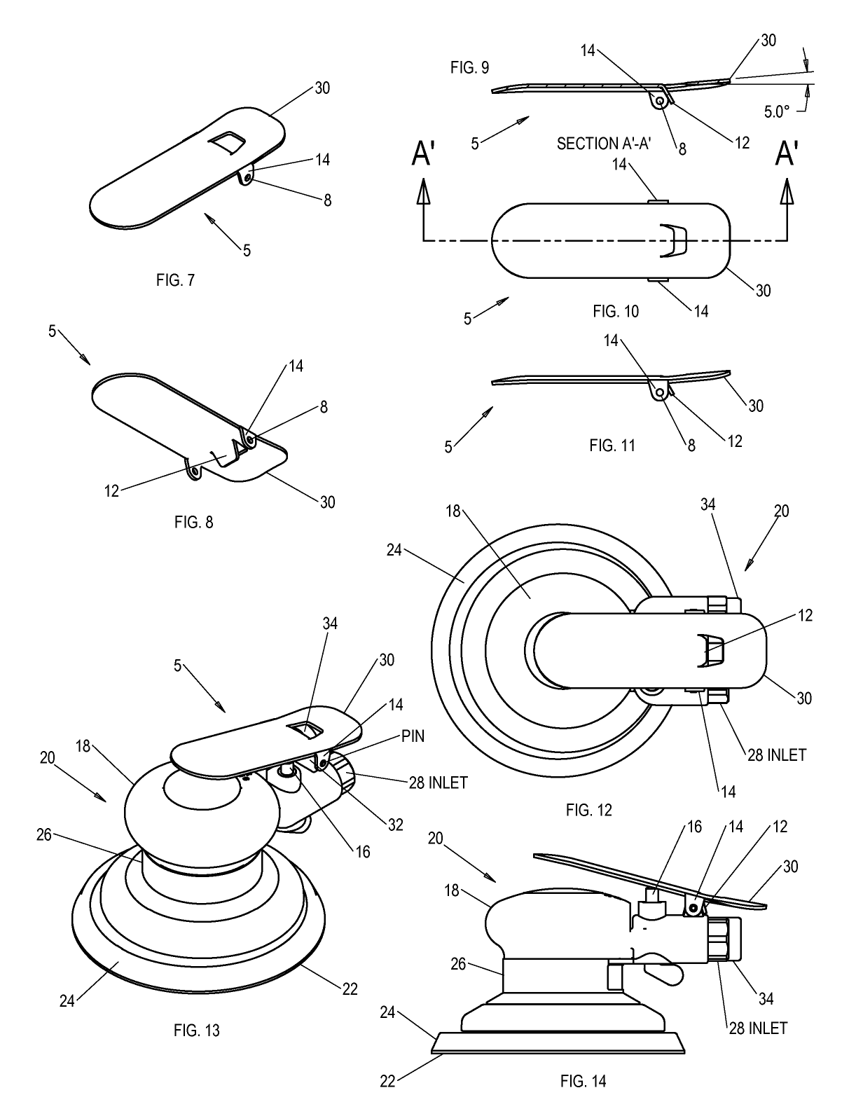

The principles of the present invention, are taught herein using a hand-held power tool as an example. This tool provides for an elongated, angled, throttle-switch-hand-support lever. The lever of the present invention is elongated relative to the levers provided in presently available tools. The elongated lever is described as having two sections, an elongated first section on which the operator's fingers and the proximal part of his palm rests, and a second, shorter section providing support to the distal part of the operator's palm. The two sections are distinguished by a bend in the single piece of material used to form the lever. This bend creates a lever shaped in the form of a very shallow “v” having an offset vertex, which creates lever arms of different lengths. The offset vertex results in the lever having one longer section and one shorter section with their common boundary being the vertex of the angle, although it must be noted that the length of the two sections combined is greater than any known lever providing similar function. The underside of the vertex of the angled lever is also where the lever is structured so as to connect to the tool. This design provides for the longer first lever section to support the front part of an operator's hand, for the shorter second lever section to support the portion of hand nearer the wrist, for the operator to control the actuator switch using a simple rocking motion of the hand, and eliminates the need for any hand lifting movements that are required to increase or decrease the rotational velocity when using a tool not fitted with the present invention. The elongation of the lever means that the lever extends over and past the inlet and exhaust protecting the operator's hand from coming into contact with the exhaust or air-intake. Note that the old style lever ends some distance before the exhaust. This exemplary tool, being a favored embodiment of the present invention, is illustrated in FIGS. 7-14.

Turning now to the drawings for more detail, FIG. 7, a perspective view, illustrates the top surface of ergonomic, elongate, angled, rocker throttle-switch-hand-support lever 5 of the present invention. Lever 5 is described as elongate, which means that it is considerably longer compared to currently available switch levers providing for the lever to protect the operator's hand from coming into contact with the exhaust or air-intake. This can be clearly observed by comparing the extension of the ergo-lever in FIG. 12 to the lack of extension in the lever illustrated in FIG. 6. FIG. 8, a perspective view of the bottom surface of the lever, illustrates the structure provided for attaching the ergonomic lever to a tool, as is also illustrated in FIGS. 13 and 14. The attachment structure consists of opposing attachment tabs 14 that extend downwards from lever 5 toward pin receiving apertures of tool 20. Attachment tabs 14 are each provided with an aperture 8 for accepting an attachment pin designed to pivotally engage elongate, throttle-switch-hand-support lever 5 to tool 20 providing for lever 5 to pivot or rotate both toward and away from actuator switch 16. As is best appreciated by looking at the example given in FIG. 9, a cross-sectional perspective side and bottom view taken along A′-A′ of FIG. 10, and at FIG. 11, there is a five degree upwards tilt of elongated rear section 30 of the throttle lever of the present invention. In the drawings, the angle of the lever is positioned at approximately the line that extends between the two opposing attachment tabs 14. It is to be understood, however, that the invention is not limited to a single angle, such as the five degree upwards tilt as exemplified in FIGS. 10 and 11. Depending on the relationship between such an ergonomic lever and the tool on which it is being used, the angle could vary. As seen best in FIG. 8, bent tab 12, formed from a cut-out of the lever, extends from the bottom surface of the throttle lever to prevent the front-end of the support and throttle lever from rotating too far upwards.

FIG. 12, a planar top view, FIG. 13, a perspective view, and FIG. 14, an elevation side view, illustrate surface treatment tool 20 fitted with elongate throttle-switch-hand-support lever 5. Tool 20 includes a power source connection, such as a compressed air connection, or may have an electrical power source connection. Housing 26 includes throttle-switch-hand-support lever 5 to control valve actuator 16 that provides for power for tool 20. Tool 20 further includes grip 18, air intake 28 and an exhaust extending from housing 26. Pad 24 holds abrasive material 22 to be applied to the article to be treated. One example of abrasive material 22 would be sandpaper. Switches similar in structure and attachment to tool 20 also may be used for electrically powered tools, although, if desired, switches for both pneumatically and electrically powered tools may be placed in other positions.

It should be appreciated that elongated, angled lever provides several advantages; the hand-support part of the lever provides support for the operator's palm to relieve pressure on the operator's wrist and arm to reduce operator fatigue and/or the possibility of being disabled with carpel tunnel syndrome. The extension also provides for the operator to ease up on the lever by pushing the palm of the hand down instead of up. The extension further relieves the operator from operating the lever with the use of his/her fingers, thus, again reducing the chance of operator fatigue and/or carpel tunnel syndrome. Moreover, the angle of the lever (the five degree upwards tilt of the rear section of the lever) also provides for added lever strength. For additional added strength, the lever is made from steel. It is to be understood, however, that the invention contemplates other greater or lesser angles of lever tilt, including zero angle of tilt, as well as manufacturing materials other than steel. If tool design dictates, the lever may be angled more or less than five degrees as illustrated and the lever may be made of other metals and other materials, such as plastic.

The foregoing description, for purposes of explanation, uses specific and defined nomenclature to provide a thorough understanding of the invention. However, it will be apparent to one skilled in the art that the specific details are not required in order to practice the invention. Thus, the foregoing description of the specific embodiment is presented for purposes of illustration and description and is not intended to be exhaustive or to limit the invention to the precise form disclosed. Those skilled in the art will recognize that many changes may be made to the features, embodiments, and methods of making the embodiments of the invention described herein without departing from the spirit and scope of the invention. Furthermore, the present invention is not limited to the described methods, embodiments, features or combinations of features but include all the variation, methods, modifications, and combinations of features within the scope of the appended claims. The invention is limited only by the claims.

What is claimed is:

1. A lever for controlling a throttle switch, comprising
an elongate lever having an upper surface, a first end, and a second end, said lever bent across its length producing an angle of less than 180 degrees between said upper surface of said first end and said upper surface of said second end so as to enable control of a throttle switch by hand-rocking the lever to rotate about its angle's vertex to exert pressure on or release pressure from said throttle switch, said lever having a length sufficient so as to support the fingers and palm of a user.

2. The lever, as recited in claim 1, wherein said throttle switch is a switch on a hand-held power tool.

3. The lever, as recited in claim 1, further having attachment tabs positioned on opposing sides of said lever, said attachment tabs providing for attachment of the lever to the handheld tool.

4. The lever, as recited in claim 2, wherein said lever extends over an exhaust-outlet or an air-intake of said hand-held power tool so as to protect the user's hand from coming into contact with the tool's exhaust-outlet or air-intake.

5. The lever, as recited in claim 4, further having a check tab formed from a partial cut-out of said lever, said check tab positioned so as to extend to said handheld tool to limit the extent the lever can rotate.

6. A lever, comprising
a throttle control lever of a hand-held power tool,
said lever being longer than wide,
said lever bent across its length producing an angle vertex and an angle of less than 180 degrees between an upper surface of a longer first end of said lever and a upper surface of a shorter second end of said lever so as to enable control of a throttle switch of said tool by hand-rocking said lever about its angle's vertex so as to exert pressure on or release pressure from said throttle switch, said lever having a length sufficient so as to support the fingers and palm of a user while the tool is in use,
attachment tabs extending downwards from opposing sides of said longer first end of said lever adjacent said vertex, each of said attachment tabs having an aperture for accepting an attachment pin so as to pivotally engage said lever with pin receiving apertures of said tool providing for said lever to rotate both toward and away from an actuator switch of said tool,
said shorter second end of said lever extending over an exhaust-outlet or an air-intake of said hand-held power tool so as to protect the user's hand from coming into contact with the tool's exhaust-outlet or air-intake.

7. The lever, as recited in claim 6, further comprising a check tab formed from a partial cut-out of said lever, said check tab positioned so as to extend to a surface of said tool to limit the extent the lever can rotate.

8. A lever in combination with a handheld tool, comprising:
a handheld power tool having a throttle switch, and
an elongate lever for controlling said throttle switch,
said lever comprising:
an upper surface, a first end, and a second end,
said lever bent across its length producing a vertex and an angle of less than 180 degrees between said upper surface of said first end and said upper surface of said second end so as to enable control of a throttle switch by hand-rocking said lever to rotate about its angle's vertex so as to exert pressure on or release pressure from said throttle switch, said lever having a length sufficient so as to support the fingers and palm of a user.

9. The lever in combination with a handheld tool, as recited in claim 8, further having attachment tabs positioned on opposing sides of said lever, said attachment tabs providing for attachment of the lever to the tool.

10. The lever in combination with a handheld tool, as recited in claim 9, said lever extending over an exhaust-outlet and/or an air-intake of the tool so as to protect user's hand from coming into contact with the tool's exhaust-outlet or air-intake.

11. The lever in combination with a handheld tool, as recited in claim 8, further having a check tab formed from a partial cut-out of said lever, said check tab positioned so as to extend to the tool to limit the extent the lever can rotate.

12. The lever in combination with a handheld tool, as recited in claim 8, further comprising where the tool is an abrading tool.

13. The lever in combination with a handheld tool, as recited in claim 8, further comprising where the tool is a sanding tool.

14. The lever in combination with a handheld tool, as recited in claim 8, further comprising where the tool is a non-rotary action sanding tool.

15. The lever in combination with a handheld tool, as recited in claim 8, further comprising where the tool is a rotary action sanding tool.

16. The lever in combination with a handheld tool, as recited in claim 8, further comprising where the tool is an orbital action sanding tool.

17. The lever in combination with a handheld tool, as recited in claim 8, further comprising where the tool is a random-orbital action sanding tool.

18. The lever in combination with a handheld tool, as recited in claim 8, further comprising where the tool is a vacuum sanding tool.

19. The lever in combination with a handheld tool, as recited in claim 8, further comprising where the tool is a non-vacuum sanding tool.

20. The lever in combination with a handheld tool, as recited in claim 8, further comprising where the tool is a vacuum random-orbital action sanding tool.
